(19) United States
(12) Patent Application Publication
(10) Pub. No.: US 2011/0027498 A1
(43) Pub. Date: Feb. 3, 2011

(54) METHOD FOR FABRICATING FIELD EMITTER ELECTRODE USING ARRAY OF CARBON NANOTUBES

(75) Inventors: Hee-Tae Jung, Daejeon (KR); Sang-Cheon Youn, Gangwon-do (KR); Young-Koan Ko, Seoul (KR)

Correspondence Address: MOORE & VAN ALLEN PLLC, P.O. BOX 13706, Research Triangle Park, NC, 27709, US

(73) Assignee: KOREA ADVANCED INSTITUTE OF SCIENCE AND TECHNOLOGY, Daejeon (KR)

(21) Appl. No.: 12/900,837

(22) Filed: Oct. 8, 2010

Related U.S. Application Data
(62) Division of application No. 11/681,262, filed on Mar. 2, 2007.

(30) Foreign Application Priority Data
May 26, 2006 (KR) 10-2006-0047655
Aug. 8, 2006 (KR) 10-2006-0074791

(51) Int. Cl. B29C 71/04; B82Y 25/00

(52) U.S. Cl. 427/550; 977/939

(57) ABSTRACT

The present invention relates to a method for fabricating a field emitter electrode, in which carbon nanotubes (CNTs) are aligned in the direction of a generated magnetic field. Specifically, the method comprises the steps of dispersing a solution of carbon nanotubes (CNTs) diluted in a solvent, on a substrate fixed to the upper part of an electromagnetic field generator, and fixing the carbon nanotubes aligned in the direction of an electromagnetic field generated from the electromagnetic field generator. According to the disclosed method, high-density and high-capacity carbon nanotubes aligned in the direction of a generated electromagnetic field can be fabricated in a simple process and can be applied as positive electrode materials for field emission displays (FEDs), sensors, electrodes, backlights and the like.

### CROSS REFERENCE TO RELATED APPLICATIONS

This application claims priority to Korean Patent Application No. 10-2006-0047655, filed May 26, 2006 and Korean Patent Application No. 10-2006-0074791, which are incorporated by reference herein.

### TECHNICAL FIELD

The present invention relates to a method for fabricating a field emitter electrode, in which carbon nanotubes (CNTs) are aligned in the direction of a generated electromagnetic field. More particularly, the present invention relates to a method for fabricating a field emitter electrode including carbon nanotubes (CNTs) aligned in the direction of a generated electromagnetic field, the method comprising the steps of dispersing a solution of carbon nanotubes (CNTs) diluted in a solvent, on a substrate fixed to the upper part of an electromagnetic field generator, and fixing the carbon nanotubes aligned in the direction of an electromagnetic field generated from the electromagnetic field generator.

### BACKGROUND ART

Generally, a field emission device is a light source based on electron emission in vacuum and refers to an element that emits light according to the principle by which electrons emitted from microparticles are accelerated by a strong electric field to impinge upon fluorescent materials. The above-mentioned field emission device has advantages such as excellent light emitting efficiency and capability of realizing light-weight and compactness as compared to conventional illumination light sources such as an incandescent bulb, as well as environmental friendliness due to no use of heavy metals unlike fluorescent lamps. Thus, it has received a great deal of attention as a next generation light source for use in a variety of illumination fields and display devices.

The performance of field emission devices significantly depends on the emitter electrode's capability to emit an electric field. Recently, carbon nanotubes (CNTs) have been actively used as the electron emitting material for an emitter electrode having excellent electron emission characteristics.

Carbon nanotube is an allotrope of carbon, which consists of carbons existing abundantly on the earth. They are tubular materials where a carbon atom is bound to other carbons in the form of a hexagonal honeycomb structure. Their diameter is about the size of a nanometer ( 1/10⁹ meter), and their length is from several hundred nanometer to several micrometer. Carbon nanotube has a large aspect ratio compared to other materials. Carbon nanotubes are known to have excellent mechanical properties and electrical selectivity, and in particular have an excellent electromagnetic field generation due to a large aspect ratio.

It has been reported that carbon nanotubes can be used as a positive electrode material for field emission displays due to their excellent field emission characteristics. In a prior paper (Kim, J.M. et al., Applied Physics Letters, 75(20):3129, 1999), carbon nanotubes were aligned in a specific direction with a polymer complex by a mechanical rubbing, and the field emission characteristics of the resulting carbon nanotubes were measured. However, in this case, there is a serious disadvantage in that the mixed polymer substance must be burned during the fabrication process, as well as a problem in that it is difficult to align carbon nanotubes over a large area in the direction of a generated electromagnetic field.

Also, a method for directly growing carbon nanotubes at high temperature to align the carbon nanotubes in a specific direction was proposed (Wong C.P., et al., Carbon, 44:253, 2006). However, this method cannot be used in practice, because it has a serious disadvantage in that indium tin oxide (ITO) glass used as a positive electrode plate for a display device cannot resist high temperatures.

In an attempt to solve the above-described problems, a method for fabricating a field emitter electrode was proposed, which comprises attaching carbon nanotubes to a substrate, applying a conductive polymer to the substrate and aligning the carbon nanotubes in a specific direction (Korean Patent Publication No. 2006-0024725). However, this method also fails to align carbon nanotubes in the direction of a generated electromagnetic field at high density over a large area, and does not overcome a disadvantage in that the polymer must be burned during the fabrication process.

Thus, there is an urgent need to develop a method for fabricating a field emitter electrode, which employs a simple process and in which carbon nanotubes are aligned in a specific direction along the direction of a generated electromagnetic field at high density over a large area.

Accordingly, the present inventors have made extensive efforts to solve the problems occurring in the prior methods for aligning carbon nanotubes in a specific direction. As a result, the present inventors have found that, when carbon nanotubes are aligned on a substrate fixed to the upper part of an electromagnetic field generator and are then fixed using a metal, it is possible to fabricate a field emitter electrode including carbon nanotubes aligned at high density over a large area, thereby completing the present invention.

### SUMMARY OF THE INVENTION

Therefore, it is an object of the present invention to provide a field emitter electrode having excellent field emission characteristics, in which carbon nanotubes aligned at high density over a large area are fixed on a substrate with a metal, as well as a fabrication method thereof.

To achieve the above object, in one aspect, the present invention provides a method for fabricating a field emitter electrode including carbon nanotubes aligned in the direction of a magnetic field, the method comprising the steps of: (a) dispersing a solution of carbon nanotubes or magnetic particle-bound carbon nanotubes diluted in an organic solvent, on a substrate fixed to the upper part of a magnetic field generator; (b) aligning the carbon nanotubes in a magnetic field generated from the magnetic field generator, in the direction of the magnetic field by evaporating the organic solvent from the solution dispersed on the substrate; and (c) depositing a metal on the substrate, in order for the carbon nanotubes aligned in the direction of the generated magnetic field to be fixed in the aligned direction even in magnetic field-free conditions.

In the present invention, the direction of the generated magnetic field is preferably perpendicular, horizontal or any angle between perpendicular and horizontal to the substrate, and the magnetic particle-bound carbon nanotubes are preferably obtained by binding the magnetic particles to the carbon nanotubes using a physical-chemical method. Also, the physical-chemical method is preferably selected from the group consisting of a method of treating the carbon nanotubes with acid, a method of subjecting the magnetic particles to a reduction reaction, and a method of plating the magnetic particles on the carbon nanotubes.

In the present invention, the magnetic field generator in the step (a) is preferably a magnet, and the magnetic field generated from the magnetic field generator preferably has a magnitude of 0.005-10 Tesla (T).

In the present invention, the magnetic particles are preferably iron (Fe)-containing particles. The iron (Fe)-containing particles are preferably selected from the group consisting of iron chloride (FeCl₃), ferrous oxide (FeO), ferric oxide (Fe₂O₃) and triiron tetroxide (Fe₃O₄).

In another aspect, the present invention provides a field emitter electrode fabricated according to said method, in which magnetic particle-bound carbon nanotubes are aligned on a substrate having a metal deposited thereon, in the direction of a magnetic field.

In still another aspect, the present invention provides a method for fabricating a field emitter electrode including carbon nanotubes aligned in the direction of a generated electric field, the method comprising the steps of: (a) dispersing a solution of carbon nanotubes diluted in an organic solvent, on a substrate fixed to the upper part of an electric field generator; (b) aligning the carbon nanotubes on the substrate in an electric field generated from the electric field generator, in the direction of the generated electric field by evaporating the organic solvent from the solution dispersed on the substrate; and (c) depositing a metal on the substrate, in order for the carbon nanotubes aligned in the direction of the generated electric field to be fixed in the aligned direction even in electric field-free conditions.

In the present invention, the direction of the generated electric field is preferably perpendicular, horizontal or any angle between perpendicular and horizontal to the substrate, and the electric field generator in the step (a) is an electric field. Also, the electric field preferably has a magnitude of 1-500 V/μm.

In the present invention, the step (a) preferably additionally comprises adding a dispersion aid. The dispersion aid is selected from the group consisting of organic solvent TOAB (tetraoctylammonium bromide), and surfactants Triton X-100, SDS (sodium dodecylsurfate), NADDBS (sodium dodecyl benzenesulfonate), and PAPPV (poly[2-(2′-ethylhexyloxy)-5-(phenylethynyl)-1,4-phenylenevinylene]).

In the present invention, the step (a) of dispersing the solution of carbon nanotubes diluted in the organic solvent, on the substrate fixed to the upper part of the electric field generator, is preferably carried out using a method selected from the group consisting of a spin coating method, a spray method, a dip coating method, and an inkjet method. Also, the steps (a) and (b) are preferably repeated 1-1000 times to increase the density of the carbon nanotubes. Furthermore, the carbon nanotubes are preferably single-wall, double-wall or multi-wall carbon nanotubes.

In the present invention, the solvent in the step (a) is preferably selected from the group consisting of water (H₂O), dimethylformamide (DMF), N-methyl-2-pyrrolidone (NMP), dimethylacetamide (DMAc), cyclohexanone, ethyl alcohol, chloroform, dichloromethane, 1,2-dichlorobenzene and ethyl ether. The substrate in the step (a) is preferably selected from the group consisting of indium tin oxide (ITO) glass, glass, quartz, glass wafers, silicon wafers, applied silica, plastics, and transparent polymers. The solvent in the step (b) is preferably removed by heating the solution to a temperature of 20-300° C. Furthermore, among the above-described organic solvents, chloroform, dichloromethane, diethyl ether and the like have good volatility, and thus can be removed even at room temperature.

In the present invention, the concentration of the carbon nanotubes in the carbon nanotube dispersion in the step (a) is preferably 0.001-1.0 wt %, and the amount of the carbon nanotubes dispersed on the substrate in the step (a) is 1 pg/cm²-1 g/cm² (amount of carbon nanotubes per unit area).

In the present invention, the metal in the step (c) is preferably deposited to a thickness of 1-5000 nm. Also, the metal in the step (c) is preferably selected from the group consisting of titanium (Ti), molybdenum (Mo), gold (Au), silver (Ag), aluminum (Al), calcium (Ca), cadmium (Cd), iron (Fe), nickel (Ni), platinum (Pt), zinc (Zn) and copper (Cu).

In yet another aspect, the present invention provides a field emitter electrode fabricated according to said method, in which carbon nanotubes are aligned on a substrate having a metal deposited thereon, in the direction of a generated electric field.

The above and other objects, features and embodiments of the present invention will be more clearly understood from the following detailed description and accompanying claims.

### BRIEF DESCRIPTION OF THE DRAWINGS

FIG. 1 is a schematic diagram showing that carbon nanotubes are aligned by the application of a magnetic field.

FIG. 2 shows transmission electron microscopy (TEM) photographs of carbon nanotubes before and after purification (left: 50,000× magnification; and right: 100,000× magnification), in which FIG. 2(a) shows carbon nanotubes containing impurities before purification, and FIG. 2(b) shows pure carbon nanotubes after purification.

FIG. 3 is a transmission electron microscopy (TEM) photograph showing magnetic particles bound to carbon nanotubes (left: 50,000× magnification; and right: 100,000× magnification).

FIG. 4 shows the substrate after removing the magnet from FIG. 1(d) and is a scanning electron microscopy (SEM) photograph showing that carbon nanotubes are aligned in the direction of a generated magnetic field (upper: 50,000× magnification; and lower: 25,000× magnification), in which FIG. 4(a) shows the substrate inclined at an angle of 80°, and FIG. 4(b) shows the substrate inclined at an angle of 45°.

FIG. 5 is a photograph of carbon nanotubes aligned in the direction of a generated magnetic field according to the present invention.

FIG. 6 is a graphic diagram showing the field emission characteristics of carbon nanotubes aligned in the direction of a generated electric field according to the present invention.

### DETAILED DESCRIPTION OF THE INVENTION, AND PREFERRED EMBODIMENTS

Carbon nanotubes have characteristic electromagnetic properties, and when carbon nanotubes bound to magnetic particles are fixed on a substrate having an electric or magnetic field flowing therethrough, it is possible to fabricate a field emitter electrode having more excellent field emission characteristics.

In one aspect, the present invention relates to a method for fabricating a field emitter electrode, in which carbon nanotubes (CNTs) are aligned in the direction of a generated magnetic or electric field.

In the present invention, a field emitter electrode, in which carbon nanotubes having magnetic particles bound thereto are aligned in the direction of a generated magnetic field or electric field, is fabricated according to the method shown in FIG. 1. Specifically, as shown in FIG. 1a, a circular magnet to be used in the present invention, having a magnitude of 1000 Gauss (G), is first prepared. Then, indium tin oxide (ITO) glass, on which carbon nanotubes are to be aligned, is attached to the magnet with a carbon adhesive (see FIG. 1b). Then, a dispersion of carbon nanotubes having magnetic particles bound thereto is dropped onto the indium tin oxide glass (see FIG. 1c). Then, a metal is deposited on the glass so as to fix the carbon nanotubes aligned in the direction of a generated magnetic field or electric field (see FIG. 1d).

The method for fabricating the field emitter electrode will be described in further detail in five divided steps.

### Step 1: Preparation of Carbon Nanotubes

Carbon nanotubes for use in the present invention are not specifically limited, and can be purchased from commercial sources or prepared according to any conventional method. For use in the present invention, carbon nanotubes should have a clean surface and contain no metal catalyst. Also, carbon nanotubes for use in the present invention are preferably single-wall, double-wall or multi-wall carbon nanotubes and can be prepared according to the Hipco (high-pressure CO disproportionation) process.

### Step 2: Binding of Magnetic Particles to Carbon Nanotubes

In order to bind magnetic particles to the carbon nanotubes prepared in the step 1, iron chloride (FeCl₃), ferrous oxide (FeO), ferric oxide (Fe₂O₃) and triiron tetroxide (Fe₃O₄) are added to a mixture of ethanol, distilled water and hexane and heated to prepare an iron-oleate complex. The prepared iron-oleate complex is mixed with oleic acid and dimethylformamide (DMF), and the carbon nanotubes prepared in the step 1 are added to the mixture. The mixture containing the carbon nanotubes added thereto is completely dissolved in 1-octadecene and then heated to evaporate the solvents from the mixture. The remaining material is washed 3-4 times with ethanol, thus preparing carbon nanotubes having magnetic particles bound thereto.

### Step 3: Dispersion of Magnetic Particle-Bound Carbon Nanotubes on Substrate

The magnetic particle-bound carbon nanotubes prepared in the step 2 are diluted in at least one solvent selected from the group consisting of dimethylformamide (DMF), N-methyl-2-pyrrolidone (NMP), dimethylacetamide (DMAc), cyclohexanone, ethyl alcohol, chlorobenzene, 1,2-dichlorobenzene and chloroform at a concentration of 0.001-1.0 wt %. Then, the dispersion of the magnetic particle-bound carbon nanotubes is dropped on an indium tin oxide (ITO) glass substrate fixed to the upper part of a magnet having a magnetic field, and the solvent is allowed to evaporate.

### Step 4: Increasing Density of Magnetic Particle-Bound Carbon Nanotubes on Substrate

On the indium tin oxide (ITO) glass substrate prepared in the step 3, from which the solvent completely evaporated, 1-2 drops of the dispersion of the magnetic particle-bound carbon nanotubes diluted in the solvent are added, and then the solvent is allowed to evaporate in high-temperature condition. To increase the density of the magnetic particle-bound carbon nanotubes, the above step can be repeated 5-20 times. By doing so, the magnetic particle-bound carbon nanotubes prepared according to the above method are aligned in the direction of the magnetic field generated from the magnet.

### Step 5: Fixing Magnetic Particle-Bound Carbon Nanotubes on Substrate

In order for the carbon nanotubes aligned by the magnetic field in the step 4 to be aligned in the aligned direction even in magnetic field-free conditions, a metal selected from the group consisting of titanium (Ti), molybdenum (Mo), gold (Au), aluminum (Al), calcium (Ca), cadmium (Cd), iron (Fe), nickel (Ni), platinum (Pt), zinc (Zn) and copper (Cu) is deposited on the substrate, thus fabricating a pure field emitter electrode.

In another aspect, the present invention relates to a method for fabricating a field emitter electrode, in which carbon nanotubes (CNTs) are aligned in the direction of a generated electric field.

In the above description, only the method comprising using the magnet as the electromagnetic field generator and aligning the carbon nanotubes by binding magnetic particles thereto has been described in detail. However, through the above description, it will be obvious to those skilled in the art that the electric field generator is an electric field, and the field emitter electrode can be fabricated either by aligning the carbon nanotubes on the substrate by adding a surfactant to the solution of the carbon nanotubes, or by aligning pure carbon nanotubes on the substrate fixed to the upper part of the electromagnetic field generator. Specifically, the field emitter electrode aligned in the direction of the generated electric field can be fabricated through the following steps:
(a) dispersing a solution of carbon nanotubes diluted in an organic solvent, on a substrate fixed to the upper part of an electric field generator;
(b) aligning the carbon nanotubes on the substrate in an electric field generated from the electric field generator, in the direction of the generated electric field by evaporating the organic solvent from the solution dispersed on the substrate; and
(c) depositing a metal on the substrate, in order for the carbon nanotubes aligned in the direction of the generated electric field to be fixed in the aligned direction even in electric field-free conditions.

According to the present invention, the field emitter electrode, in which carbon nanotubes (CNTs) are aligned in perpendicular, horizontal or any angle between perpendicular and horizontal to the substrate according to the direction of a generated electromagnetic field, can fabricated. Also, the characteristic field emission properties of the carbon nanotubes aligned at high density over a large area in the direction of a generated electromagnetic field can be used to fabricate a field emitter electrode having a greatly improved field emission effect. The field emitter electrode fabricated according to the method of the present invention can be used as a field emitter electrode for displays, and can also be applied in scanning electron microscopes (SEM) and transmission electron microscopes (TEM), which employ field emission phenomena.

### EXAMPLE

The present invention will hereinafter be described in further detail by examples. However, it is to be understood that these examples can be modified into other various forms, and the scope of the present invention is not intended to be limited to such examples. Such examples are given to more fully describe the present invention for a person skilled in the art.

### Example 1

### Preparation of Carbon Nanotubes

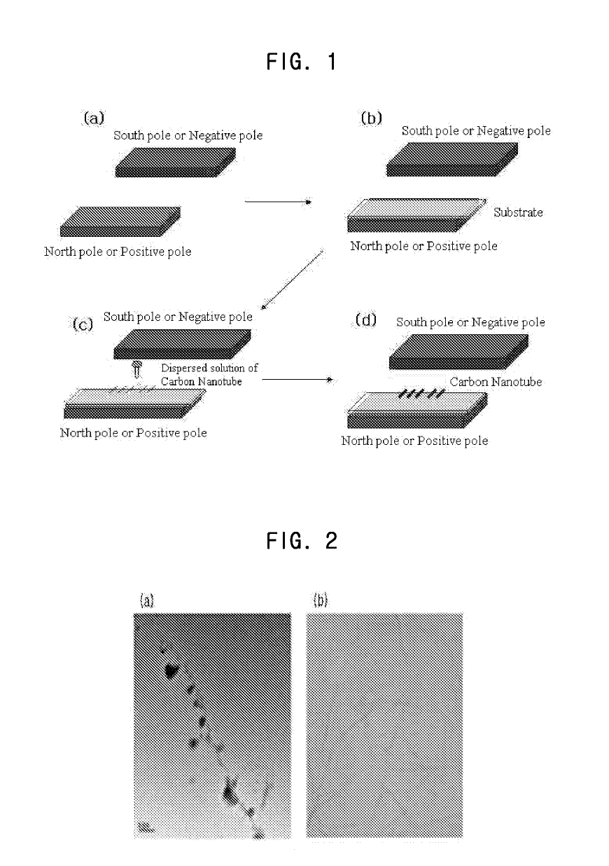

500 mg of carbon nanotubes were placed in a furnace at 365° C., in which they were thermally treated for 90 minutes, while 0.1 SLM (standard liters per minute) of air was injected into the furnace. The thermally treated carbon nanotubes were added to 500 ml of hydrochloric acid, sonicated for 1 hour and filtered through a 1-μm filter. Then, the filtered carbon nanotubes were added to 500 ml of hydrochloric acid, sonicated for 1 hour and filtered through a 1-μm filter. The hydrochloric acid treatment process was repeated 3-5 times to purify the carbon nanotubes. Also, the carbon nanotubes were observed with transmission electron microscopy (TEM) photographs before and after the purification process (see FIG. 2). As a result, as shown in FIG. 2, the carbon nanotubes contained impurities before purification (see FIG. 2a), but they contained no impurities after purification (see FIG. 2b). The purified carbon nanotubes were immersed in a mixture of sulfuric acid and hydrogen peroxide (4:1 v/v) and stirred for 9 hours to cut them. Then, the resulting carbon nanotubes were diluted in distilled water, filtered through a 500-nm filter and dried in an oven at 120° C. for at least 12 hours.

### Example 2

### Binding of Magnetic Particles to Carbon Nanotubes

10.8 g of iron chloride (FeCl₃.6H₂O) and 36.5 g of sodium oleate (Cl₈H₃₃NaO₂) were added to a mixture of 80 ml of ethanol, 60 ml of distilled water and 140 ml of hexane, and heated at 70° C. for 4 hours, thus preparing an iron-oleate complex. 12 g of the prepared iron-oleate complex, 2.83 g of oleic acid and 3 ml of dimethylformamide (DMF) solvent were mixed with each other, and 150 mg of the carbon nanotubes prepared in Example 1 were dispersed in the mixture.

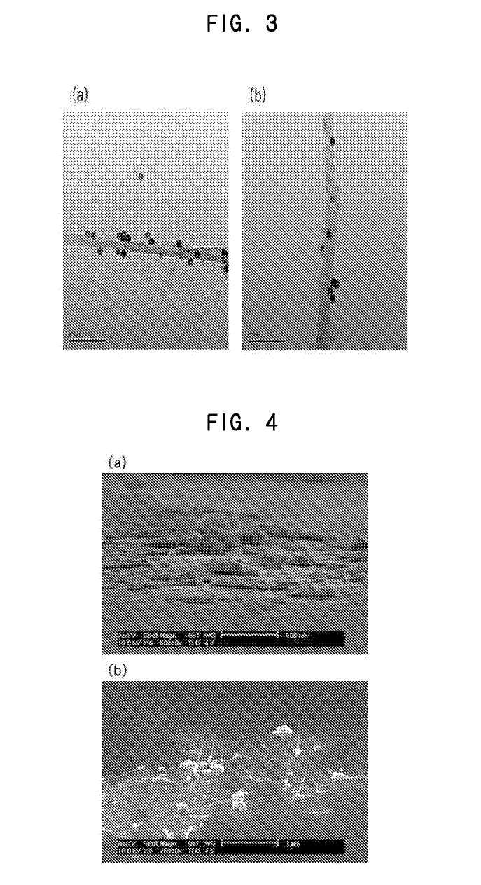

Then, the mixture was completely dissolved in 130 ml of 1-octadecene at room temperature, and the mixture was heated to a temperature of 320° C., allowed to react for 30 minutes at that temperature, and then cooled to room temperature. The reaction material was washed 3-4 times with ethanol, centrifuged to remove the supernatant, and then filtered through a 1-μm filter, thus affording carbon nanotubes having ferric oxide (Fe₂O₃) bound thereto. The prepared carbon nanotubes were observed with a transmission electron microscopy (TEM) photograph (see FIG. 3). As a result, as shown in FIG. 3, it could be seen that the carbon nanotubes had the magnetic particles bound thereto.

### Example 3

### Dispersion of Magnetic Particle-Carbon Nanotubes on Substate

5 mg of the magnetic particle-carbon nanotubes prepared in Example 2 were dispersed in 50 ml of dimethylformamide (DMF), and 10 ml of the dispersion was then diluted in 40 ml of pure dimethylformamide (DMF).

Meanwhile, indium tin oxide (ITO) glass was fixed on a magnet having a magnetic field of 1000 gauss, and then placed in an oven at 120° C. As the temperature of the indium tin oxide (ITO) glass was increased to 120° C., about 1 μl of said solution of the magnetic particle-bound carbon nanotubes diluted in dimethylformamide was dropped on the indium tin oxide (ITO) glass in the oven and maintained at 120° C. for 10 minutes to evaporate the dimethylformamide (DMF).

### Example 4

### Increasing Density of Magnetic Particle-Bound Carbon Nanotubes on Substrate

On the indium tin oxide (ITO) glass substrate, which was prepared in Example 3 and from which the dimethylformamide (DMF) was completely evaporated, about 1 μl of the solution of the magnetic particle-bound carbon nanotubes diluted in dimethylformamide was further dropped. Then, the temperature of the oven containing the glass substrate was 120° C. for 10 minutes to evaporate the dimethylformamide (DMF). In order to increase the density of the magnetic particle-bound carbon nanotubes on the substrate, this step was repeated several tens of times.

The substrate prepared according to the above-described method was observed with a transmission electron microscopy (SEM) photograph and, as a result, it could be seen that the magnetic particle-bound carbon nanotubes were aligned in the direction of the magnetic field generated from the magnet (see FIG. 4).

### Example 5

### Fixation of Magnetic Particle-Bound Carbon Nanotubes on Substrate

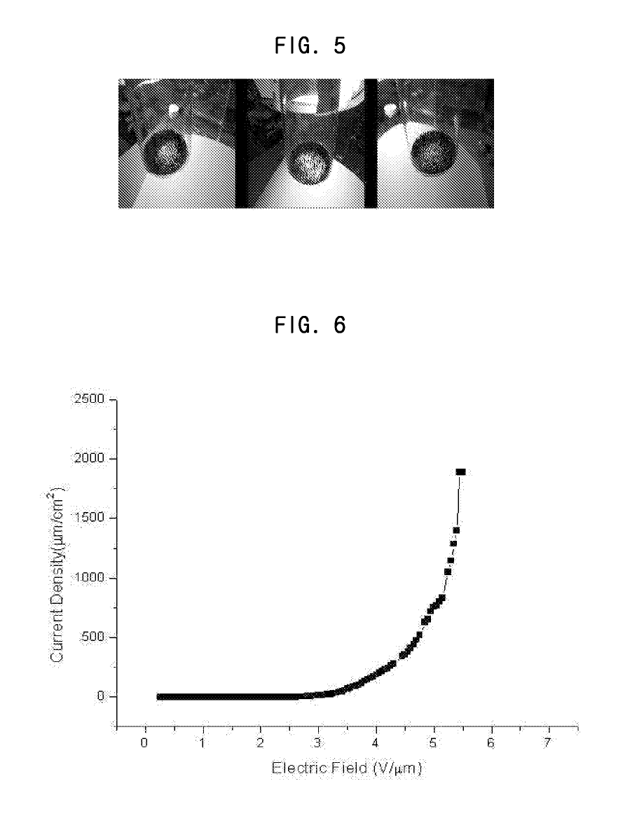

In order for the magnetic particle-bound carbon nanotubes to be aligned in the direction of the generated magnetic field even in magnetic field-free conditions, titanium (Ti) was deposited on the substrate to total heights of 30 nm and 70 nm at a rate of 0.5 nm/sec at room temperature using an e-beam deposition system (MooHan Co. Ltd., Korea). After completion of the deposition, the magnet was removed, thus fabricating a pure field emitter electrode (see FIG. 5). As shown in FIG. 5, it could be seen that the carbon nanotubes in the field emitter electrode were aligned in the direction of the generated magnetic field.

Also, in order to examine the field emission characteristics of the carbon nanotube electrodes in the fabricated field emitter electrode, the current density of the carbon nanotubes according to an electric field was measured (see FIG. 6). As shown in FIG. 6, it could be seen that the field emitter electrode according to the present invention had excellent field emission characteristics.

### INDUSTRIAL APPLICABILITY

As described above, according to the present invention, a field emitter electrode, in which high-density and high-capacity carbon nanotubes (CNTs) are aligned in the direction of a generated electromagnetic field can be fabricated in a simple process. The field emitter electrode according to the present invention can be used as a field emitter electrode for displays, and can also be applied in scanning electron microscopes (SEM) and transmission electron microscopes (TEM), which employ field emission phenomena.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

1. A method for fabricating a field emitter electrode including carbon nanotubes aligned in the direction of a magnetic field, the method comprising the steps of:
(a) dispersing a solution of carbon nanotubes or magnetic particle-bound carbon nanotubes diluted in an organic solvent, on a substrate fixed to the upper part of a magnetic field generator;
(b) aligning the carbon nanotubes in a magnetic field generated from the magnetic field generator, in the direction of the magnetic field by evaporating the organic solvent from the solution dispersed on the substrate; and
(c) depositing a metal on the substrate, in order for the carbon nanotubes aligned in the direction of the generated magnetic field to be fixed in the aligned direction even in magnetic field-free conditions.

2. The method for fabricating a field emitter electrode according to claim 1, wherein the direction of the generated magnetic field is perpendicular, horizontal or any angle between perpendicular and horizontal to the substrate.

3. The method for fabricating a field emitter electrode according to claim 1, wherein the magnetic particle-bound carbon nanotubes are obtained by binding magnetic particles to the carbon nanotubes using a physical-chemical method.

4. The method for fabricating a field emitter electrode according to claim 3, wherein the physical-chemical method is selected from the group consisting of a method of treating the carbon nanotubes with acid, a method of subjecting the magnetic particles to a reduction reaction, and a method of plating the magnetic particles on the carbon nanotubes.

5. The method for fabricating a field emitter electrode according to claim 3, wherein the magnetic particles are iron (Fe)-containing particles.

6. The method for fabricating a field emitter electrode according to claim 1, wherein the magnetic field generated from the magnetic field generator has a magnitude of 0.005-10 Tesla (T).

7.-12. (canceled)

13. The method for fabricating a field emitter electrode according to claim 1, wherein the step (a) of dispersing the solution of carbon nanotubes diluted in the organic solvent on the substrate fixed to the upper part of the electric field generator, is carried out using a method selected from the group consisting of a spin coating method, a spray method, a dip coating method, and an inkjet method.

14. The method for fabricating a field emitter electrode according to claim 1, wherein the steps (a) and (b) are repeated 1-1000 times to increase the density of the carbon nanotubes.

15. The method for fabricating a field emitter electrode according to claim 1, wherein the solvent in the step (a) is selected from the group consisting of water (H₂O), dimethylformamide (DMF), N-methyl-2-pyrrolidone (NMP), dimethylacetamide (DMAc), cyclohexanone, ethyl alcohol, chloroform, dichloromethane, 1,2-dichlorobenzene and ethyl ether.

16. The method for fabricating a field emitter electrode according to claim 1, wherein the substrate in the step (a) is selected from the group consisting of indium tin oxide (ITO) glass, glass, quartz, glass wafers, silicon wafers, applied silica, plastics, and transparent polymers.

17. The method for fabricating a field emitter electrode according to claim 1, wherein the concentration of the carbon nanotubes in the carbon nanotube dispersion in the step (a) is 0.001-1.0 wt %.

18. The method for fabricating a field emitter electrode according to claim 1, wherein the solvent in the step (b) is removed by heating the solution to a temperature of 20-300° C.

19. The method for fabricating a field emitter electrode according to claim 1, wherein the amount of the carbon nanotubes dispersed on the substrate in the step (a) is 1 pg/cm²-1 g/cm² (amount of carbon nanotubes per unit area).

20. The method for fabricating a field emitter electrode according to claim 1, wherein the metal in the step (c) is deposited to a thickness of 1-5000 nm.

21. The method for fabricating a field emitter electrode according to claim 1, wherein the metal in the step (c) is selected from the group consisting of titanium (Ti), molybdenum (Mo), gold (Au), silver (Ag), aluminum (Al), calcium (Ca), cadmium (Cd), iron (Fe), nickel (Ni), platinum (Pt), zinc (Zn) and copper (Cu).
